(19) United States
(12) Patent Application Publication
(10) Pub. No.: US 2025/0314883 A1
(43) Pub. Date: Oct. 9, 2025

(54) Light Control Device

(71) Applicant: Envisics Ltd, Milton Keynes (GB)

(72) Inventors: Yiren Xia, Milton Keynes (GB); Timothy Smeeton, Milton Keynes (GB)

(21) Appl. No.: 19/170,046

(22) Filed: Apr. 3, 2025

(30) Foreign Application Priority Data
Apr. 9, 2024 (GB) 2405038.7

(51) Int. Cl. G02B 27/01; B60K 35/23

(52) U.S. Cl. CPC G02B 27/0101; B60K 35/23; G02B 27/0149; B60K 2360/23; G02B 2027/0154

(57) ABSTRACT

A head-up display for a vehicle is provided. The head-up display comprises an optical component arranged to emit light from a first surface thereof. The head-up display further comprises a light control layer having a plurality of elongate structures and being arranged in cooperation with the optical component on an optical path between the first surface and an eye-box of the head-up display. Finally, the head-up display comprises a driver arranged to move the light control layer between a first position and a second position. The motion is on a plane parallel to a plane of the first surface.

### CROSS-REFERENCE TO RELATED APPLICATIONS

This application claims priority under 35 U.S.C. § 119 to UK Patent Application GB 2405038.7 titled “Light Control Device,” filed on Apr. 9, 2024, and currently pending. The entire contents of GB 2405038.7 are incorporated by reference herein for all purposes.

### FIELD

The present disclosure relates to a light control layer, a turning film, a reflection suppression device and a glare mitigation device. The present disclosure also relates to a head-up display system comprising the light control layer. The present disclosure further relates to methods of processing display light optionally using the light control layer.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

A display system may comprise an optical or wavefront replicator to expand the viewing window or so-called “eye-box” of the display system. The replicator may be arranged to replicate spatially modulated light encoding picture content to form a plurality of replicas thereof. For example, if the spatially modulated light is a holographic wavefront, the replicator may be arranged to form a plurality of replicas of the holographic wavefront. In embodiments, the replicator may be a waveguide, as described below. For example, the waveguide may comprise an input port arranged to receive the spatially modulated light. The waveguide may comprise a pair of surfaces arranged to waveguide the spatially modulated light received at the input therebetween. A first surface of the pair of surfaces may be partially-transmissive partially-reflective. The first surface may be arranged to form the plurality of replicas of the spatially modulated light by wavefront division. At least a portion of the first surface may be said to form an output port of the replicator/waveguide. The replicator may be arranged such that the plurality of replicas are output or relayed towards an optical combiner such as a curved optical component, such as a vehicle windscreen. The display system may therefore be a head-up display system for augmented reality. The display system may be further arranged such that the plurality of replicas is relayed towards a viewing window/eye-box of the display system.

Ambient light can cause glare to be visible to the user. An arrangement (or array) of elongate (prismatic) structures has been previously disclosed to suppress glare at the eye-box. Additionally or alternatively, such a plurality or series of elongate prismatic structures extending parallel to the general direction of propagation of the replicas through the waveguide, can be used to apply a “turn” to the light output from the waveguide. That is, by utilising an angled face of the cross-section of the structures to provide refraction, the angle of the light exiting the waveguide can be adjusted compared to the angle of the light being inputted to the waveguide. This allows the position of the eye-box to be fine-tuned. Such a series of elongate structures can therefore be arranged as what is known in the art as a “turning film”.

Alternatively or additionally, using a series of elongate structures—e.g. extending perpendicular to the direction of propagation of the replicas through the waveguide—and optionally by making specific surfaces of the structures opaque (or near opaque), sunlight and other ambient light incident on the reflective surface of the waveguide can be prevented from reaching the user/eye-box and causing visible glare. Hence, glare mitigation is provided. These structures and the problems they address are further discussed, for example, in previous British patent applications 2401627.1, 2317241.4 and 2303536.3, filed 7 Feb. 2024, 10 Nov. 2023 and 10 Mar. 2023 respectively and incorporated herein by reference.

In summary, a plurality of elongate elements each having a substantially triangular cross-section can be utilised as a turning film and/or glare mitigation component. It has also been found that other cross-sections (such as parallelogram cross-sections or cross-sections with curved sides or edges) can also achieve the same effect. A prism or prismatic structure is referred to herein by way of example only of an elongate structure optionally having three-sides in cross-section.

However, it has been observed that using such structures can cause visual artefacts to be present at the eye-box and/or content of the intended image to be lost. Refraction of the wavefront of replicas through the arrangements of elongate structures, combined with internal reflection within said structures, can cause bands to appear. These bands appear to the viewer as dark or black stripes in the picture perceived from the eye-box.

Some embodiments use a planar glass waveguide to achieve 2D pupil expansion and meet the desired eye-box size and field of view. In accordance with some embodiments, on top of the second waveguide (that is, after or downstream of the second waveguide on the optical path to the viewer), there is an anti-glare structure to prevent sunlight from reaching driver's eyes via a direct or indirect reflection from a surface of the second waveguide. A prismatic periodic structure is advantageous due to its ability to be formed in a planar format (e.g. by implementing it as a Fresnel structure), superior glare mitigation, ease of manufacturing. One prism surface can be utilised for transmission, while the other surface (side facet, usually frosted and/or black painted) blocks the transmission of some rays, which not only reduces optical efficiency but can introduce dark bands in the image perceived by eye (˜1 m from the prismatic structure). The same artefact can also be observed when using a prismatic turning film.

A prismatic periodic structure may be used as a final optical surface of the display system (that is, ignoring the windscreen, which acts as an optical combiner) after a planar waveguide (pupil expander) to 1/steer the image content to the right eye-box position (turning film) and 2/reduce or prevent sun reflections reaching the eye-box (glare mitigation). When configured as the turning film, the prism lines (i.e. the elongate direction) may be parallel to a short axis or dimension of the waveguide; when configured for glare mitigation (with no turning), the prism lines may be parallel to a long axis or dimension of the waveguide; and when configured for both functions, the prism lines are not parallel to either the short or long axis and the elongate direction of the top and bottom prism layers may not be parallel to each other. These prismatic structures are proven to be easily manufacturable, effective in turning/glare mitigation but may affect the image quality (especially when placed at distance from the image plane). The root cause is that prismatic periodic structures can break the continuity of the image. This is because the side facet of the prism (the surface not designed for optical transmission, usually frosted and/or black painted) may block some rays. It is not possible for the side facet to remain parallel to the rays both in the structure and in air, due to the difference of refractive index between the two. Therefore, there are always rays hitting the side facet and not transmitting through the structure, resulting in dark bands and loss of content. The dark bands may be parallel to the prism lines in the different configurations.

Some examples minimise the dark bands by minimising the prism pitch (scale down the structure). In this case, although the overall area of dark band remains the same, each individual dark band is narrower and can become invisible to the eye. However, a reduction in prism pitch can cause issues with diffraction due to the small lengths between the side facets of the prisms.

In a first aspect, a head-up display for a vehicle is provided. The head-up display has or forms a viewing window or so-called “eye-box”. The head-up display comprises an optical component arranged to emit light from a first surface thereof. The emission of light may be to a user of the head-up display. The light may be head-up display light or display light or picture light-that is, light forming the imagery or picture of the head-up display. The optical component-more specifically, the first surface thereof-may be conducive to (sunlight) glare. The first surface may be arranged in head-up display operation to receive sunlight. For example, the first surface may substantially face upwardly. The first surface may be substantially planar with a dashboard of the vehicle housing the head-up display. That is, the optical component may provide an optical path for sunlight to reach the eye-box-optionally via a plurality of different paths involving one or more reflections from one or more components of the head-up display. The head-up display further comprises a light control layer having a plurality of elongate structures. The light control layer is arranged in cooperation with the optical component on an optical path between the first surface and an eye-box of the head-up display. The light control layer may be moveably arranged in cooperation with the optical component (in other words, the light control layer is affixed or arranged such that it can move relative to the optical component). Finally, the head-up display comprises a mechanical driver or driver mechanism arranged to move the light control layer between a first position and a second position. The motion is on a plane parallel to a plane of the first surface.

The elongate structures describe any three-dimensional shape with an end face (i.e. cross section) and that extends away from the end face (i.e. is elongate). Many shapes of end face and extension are suitable—but some embodiments comprise a generally triangular cross section. For example, the extension need not be straight or linear, but instead may be curved. The plurality of the structures need not be regularly or evenly arranged, indeed there may be gaps in the array/arrangement. The driver may be any actuator, motor, servo, or other device suitable for providing the necessary motion.

In other words, a head-up display (or a display system/projector) for a vehicle is provided. The head-up display (display system/projector) comprises an optical component (e.g. a wavefront replicator such as a substantially planar waveguide) having a reflective surface (arranged, during head-up display operation, or display operation/projection), in a configuration that is conducive to sunlight glare. A light control layer is (moveably) disposed on the optical component to receive sunlight on an optical path to the reflective surface (or arranged to suppress reflections of sunlight received on an optical path to the reflective surface/arranged to suppress the specular reflection of ambient light incident on the optical component). A (e.g. linear) motion mechanism is arranged to (repeatedly/continuously) move (or vibrate/oscillate) the light control layer between a first position and a second position. The motion is (or has a component) parallel to (the plane of) the reflective surface.

There is also disclosed herein a glare suppression device arranged to couple with a light emission surface of a display system. The light emission surface may be substantially planar. The light emission surface may be arranged, in use, in a configuration that receives sunlight. For example, the light emission surface may substantially face the sky when installed in a vehicle. There may be an optical path between the light emission surface and the sky. There may be an optical path between the light emission surface and a viewing window e.g. eye-box of the display system. The optical path may include a transmission or reflection from an optical combiner e.g. windscreen on a vehicle housing the display system. The display system may be a head-up display. The light emission surface may be partially reflective. The light emission surface is therefore conducive to glare or susceptible to causing glare. The light emission surface may comprise a polished surface, for example, such as polished glass or plastic. The light emission surface may be the cover glass of a head-up display, for example. In some embodiments, the light emission surface is the output surface of a waveguide such as the output face of a substantially planar—e.g. slab-shaped—waveguide. The glare suppression device comprises a plurality or array of elongate elements. In some embodiments, the elongate elements have a substantially triangular cross-section. The plurality of elongate elements may be referred to as elongate prisms or, simply, prisms for short. An active face of each prism may be configured, in use, to receive light forming a picture. The bases of the prisms may form a substantially planar surface of the glare suppression device that may couple with the light emission surface. Each prism may further comprise a passive face. The prisms may be arranged in a regular array. The light may comprise a wavefront comprising spatially modulated light. The wavefront may be a holographic wavefront. The light may comprise a plurality of replicas of the wavefront. The glare suppression device is arranged to move (e.g. oscillate back and forth) in order to reduce artefacts caused by the plurality of elongate elements. The glare suppression device reduces glare at the eye-box whilst minimising image artefacts. That is, the glare suppression device reduces the amount of sunlight reflecting to the eye-box via any optical path.

In this way, the motion of the light control layer reduces the appearance of the dark bands-caused by the cross-sectional shape of the elongate elements/structures-and recovers at least some of the image content that would otherwise be lost. The motion means that each replica, at some point across the range of motion, will arrive at the light control layer at a position where it will be propagated through the light control layer and not reflected and/or refracted away (and lost). As such, through the motion range of the light control layer, each replica has at least one moment in time when said replica can be propagated through the light control layer and not lost. This means the eye observes all parts of the image and no image content is lost.

Furthermore, the motion of the light control layer means that the positions of the dark bands (where no replicas are outputted from the light control layer) are constantly moving. As such, over a period of time, there will be no part of the output side of the light control layer through which no replica will travel. This causes the eye to perceive fewer and/or less severe dark banding within the eye-box.

Therefore, the two problems observed by the inventors relating to the light control device are addressed with a single device.

In other words, present disclosure uses a linear moving mechanism to vibrate or oscillate the elongate structure (which may be a prismatic periodic structure), but not the waveguide/replicator. This disclosure uses mechanical vibration to mitigate image artefacts perceived by eye in display system, such as a waveguide HUD. As the artefacts are from prismatic periodic structures, a high frequency, linear displacement is effective against dark bands and loss of content, both of which are position dependent between the waveguide and the structure. This method may lead to acceptable image quality for prismatic periodic structure to be implemented in a waveguide HUD, for example.

The motion may be linear. Linear motion is sufficient, but the present disclosure can also conversely work with curved motion. The choice of motion depends on the content to be displayed and if there is a need to boost luminance for certain areas of the image.

The light control layer may be arranged to change (or control) an angle of light propagating therethrough. In other words, the light control layer may be arranged to change (or control) an angle of light propagating through the light control layer. In this way, the light control layer may be a turning film, or more specifically may be the turning film as described above. The first surface may have a first dimension and a second dimension. The second dimension may be parallel to the direction of replication of the replicas throughout the optical component (waveguide). The first dimension may be larger than the second dimension, and the motion may be substantially parallel to the first dimension. The plurality of elongate structures may be arranged such that each elongate structure extends in a direction substantially parallel to the second dimension. If the optical component is a replicator/waveguide, the direction of replication of the light may be parallel to the second dimension. In this way, the turning function as described above is provided with a reduction in the dark bands and lost image content.

The first surface may be at least partially reflective and the light control layer may be arranged to suppress reflections of sunlight received on an optical path to the eye-box (and/or an optical path to the first surface). The first surface may have a first dimension and a second dimension. The second dimension may be parallel to the direction of replication of the replicas throughout the optical component (waveguide). In this way, the glare mitigation as described above is provided with a reduction in the dark bands and lost image content.

The first dimension may be larger than the second dimension, and the motion may be substantially parallel to the second dimension. The plurality of elongate structures may be arranged such that each elongate structure extends in a direction substantially parallel to the first dimension. If the optical component is a replicator/waveguide, the direction of replication of the light may be parallel to the second dimension.

The head-up display may further comprise a compensation layer located on an optical path between the first surface and the light control layer. The compensation layer may have a plurality of elongate structures arranged such that each elongate structure extends in a direction substantially parallel to the first dimension. The elongate structures of the compensation layer may be shaped to compensate for a distortion to the light caused by a corresponding one of the elongate structures of the light control layer.

In other words, the head-up display may further comprise a second layer of elongate structures (or, in other words as discussed above, prisms). This second layer of prisms are arranged to compensate for distortion of light caused by the elongate structures (prisms) of the light control layer.

By providing a compensation layer, any distortion to the image to be displayed caused by the elongate structures of the light control layer is compensated for, reducing distortion to the image viewed by the user. In other words, the plurality of elongate structures of the compensation layer are complementary to the plurality of elongate structures of the light control layer.

The motion may be at an angle of 5 to 35 degrees relative to the second dimension. The plurality of elongate structures may be arranged such that each elongate structure extends in a direction at an angle of 5 to 35 degrees relative to the first dimension.

The head-up display may further comprise a compensation layer located on an optical path between the first surface and the light control layer. The compensation layer may have a plurality of elongate structures arranged such that each elongate structure extends in a direction at an angle of 145 to 175 degrees relative to the first dimension. The elongate structures of the compensation layer may be shaped to compensate for a distortion to the light caused by a corresponding one of the elongate structures of the light control layer.

The shape each of the elongate structures provides a turning effect in a single and different plane (as described above). By angling the two structures in this way, the compensation layer compensates for the turn provided by the light control layer, in all planes aside from the one desired (to achieve the effect of the turning film as described above). In this way, the glare mitigation with an integrated turning function is provided with a reduction in the dark bands and lost image content.

The optical component may be a replicator arranged to receive light and replicate the light to form a plurality of replicas of the light. This may be achieved by waveguiding between a reflective surfaces and a transmissive-reflective surface, the transmissive-reflective surface forming an output surface for the plurality of replicas of the light.

The motion may have a frequency of at least 2 hertz, optionally in the range of 2 to 60 hertz. Surprisingly, the inventors have found that a low frequency of motion still has the desired effect. Unlike other optical systems and components, where low frequency of motion (that is, a frequency lower than the eye can perceive) is undesirable, as the viewer will perceive a “flickering” of the image caused by the motion of the component. However, the inventors have found that even a low frequency can address the specific problem discussed above, without the user perceiving the motion.

In other words, by introducing this relative displacement between the waveguide and the structure, the dark bands and loss of content become invisible (or reduced) to the eye. The motion may have a magnitude of at least 0.3 millimetres, optionally in the range of 0.3 to 3 millimetres. This magnitude of motion may be dependent on the pitch of the elongate structures.

The head-up display may further comprise an optical combiner located on an optical path between the optical component and the user. The optical combiner may be a windscreen of a vehicle. The elongate structures may be prismatic structures.

In a second aspect, a method of operating a head-up display for a vehicle is provided. The method comprises a step of emitting light from a first surface of an optical component of the head-up display. The method then comprises a step of moving a light control layer, using a driver, between a first position and a second position. The light control layer has a plurality of elongate structures and is arranged in cooperation with the optical component on an optical path between the first surface and an eye-box of the head-up display. The motion is on a plane parallel to a plane of the first surface.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 is a diagrammatic representation of a wavefront of light passing through a periodic prismatic structure;

FIG. 7 is a perspective view of a replicator with a turning film;

FIG. 8 is a diagrammatic representation of an eye-box or viewing window of a head-up display image displayed using the device of FIG. 7;

FIG. 9 is a perspective view of a replicator with a glare mitigation layer;

FIG. 10 is a diagrammatic representation of an eye-box or viewing window of a head-up display image displayed using the device of FIG. 9;

FIG. 11 is a perspective view of a replicator with a glare mitigation layer and an integrated turning function;

FIG. 12 is a diagrammatic representation of an eye-box or viewing window of a head-up display image displayed using the device of FIG. 11;

FIG. 13 is a perspective view of a device according to a first embodiment of the disclosure;

FIG. 14 is a diagrammatic representation of an eye-box or viewing window of a head-up display image displayed using the device of FIG. 13;

FIG. 15 is a perspective view of a device according to a second embodiment of the disclosure;

FIG. 16 is a diagrammatic representation of an eye-box or viewing window of a head-up display image displayed using the device of FIG. 15;

FIG. 17 is a perspective view of a device according to a third embodiment of the disclosure; and

FIG. 18 is a diagrammatic representation of an eye-box or viewing window of a head-up display image displayed using the device of FIG. 17.

The same reference numbers will be used throughout the drawings to refer to the same or like parts.

### DETAILED DESCRIPTION

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise. A structure described as being formed at an upper portion/lower portion of another structure or on/under the other structure should be construed as including a case where the structures contact each other and, moreover, a case where a third structure is disposed there between.

In describing a time relationship-for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used. Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

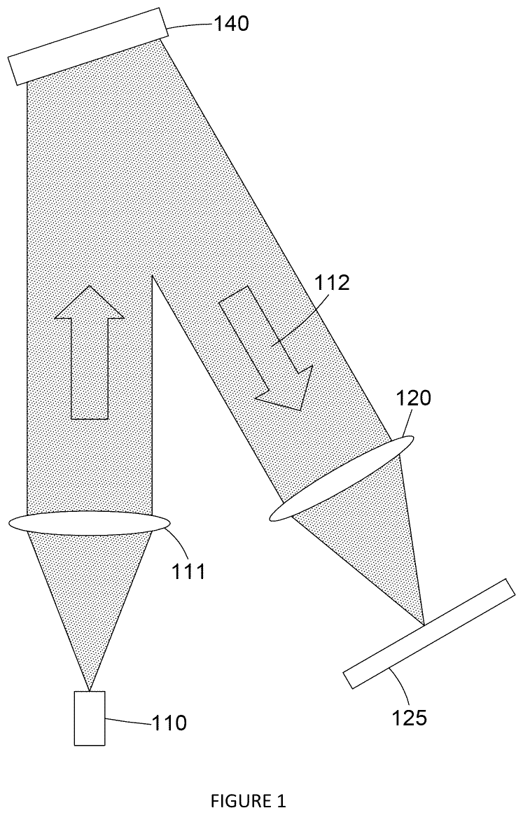

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field. The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

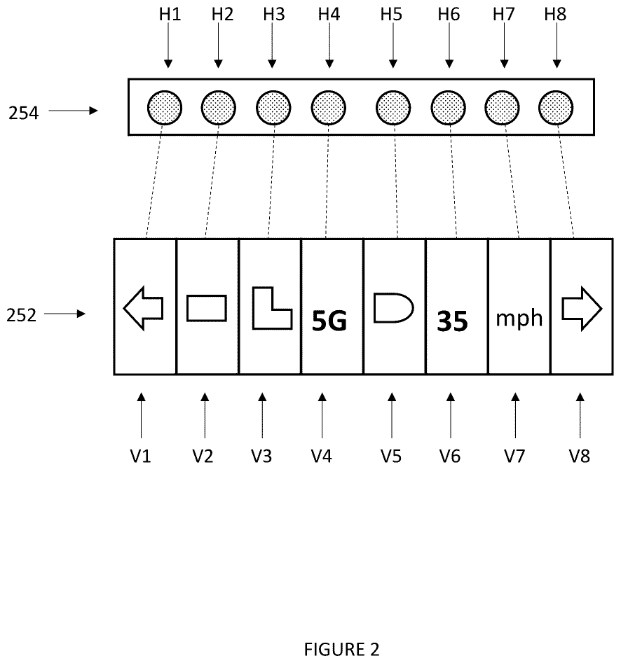

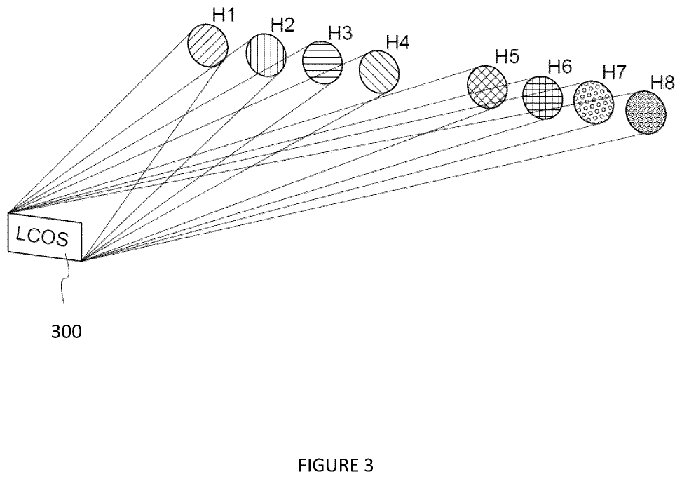

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

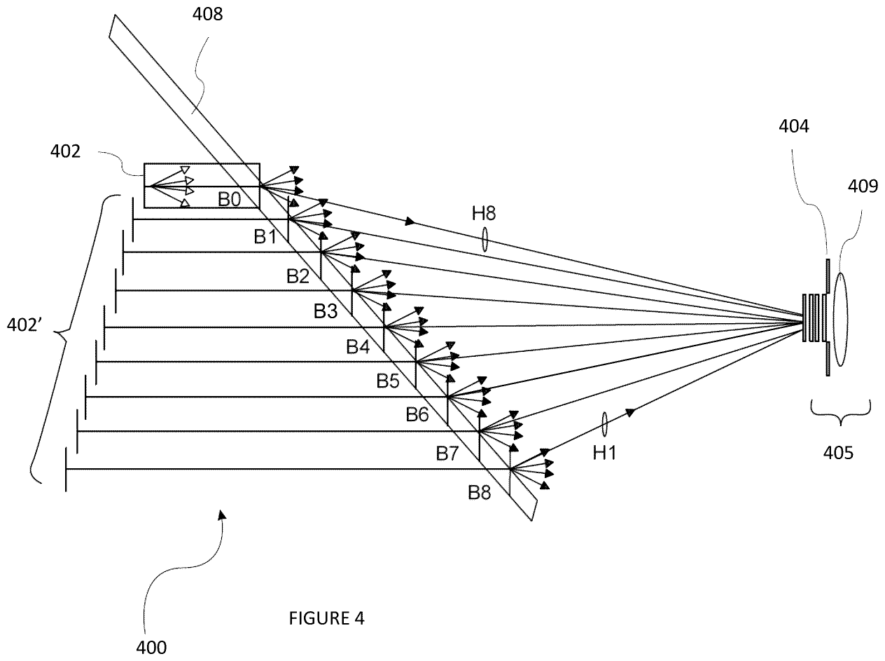

FIG. 4 shows a system 400, including a display device that displays a hologram that has been calculated as illustrated in FIGS. 2 and 3. The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

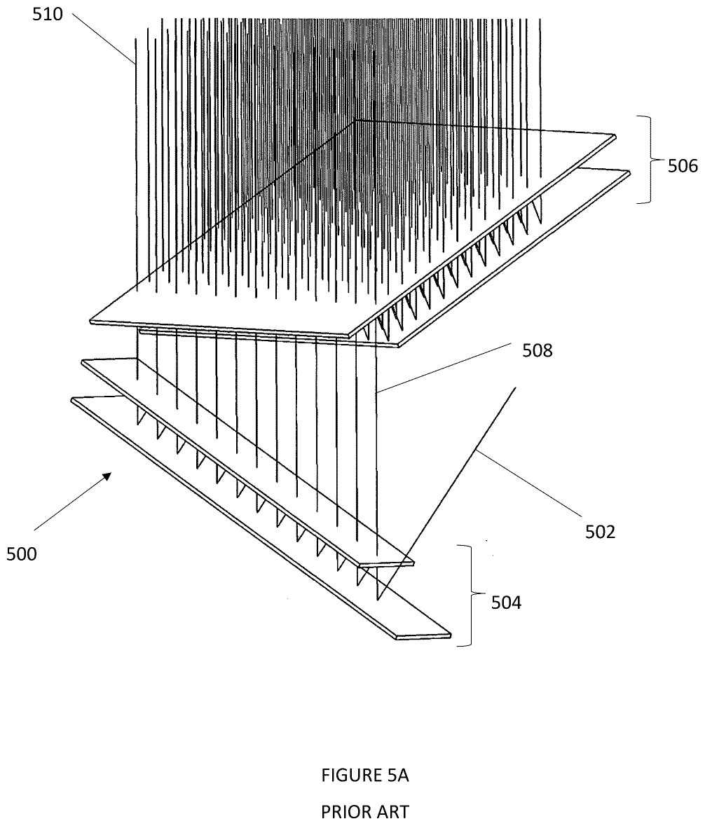

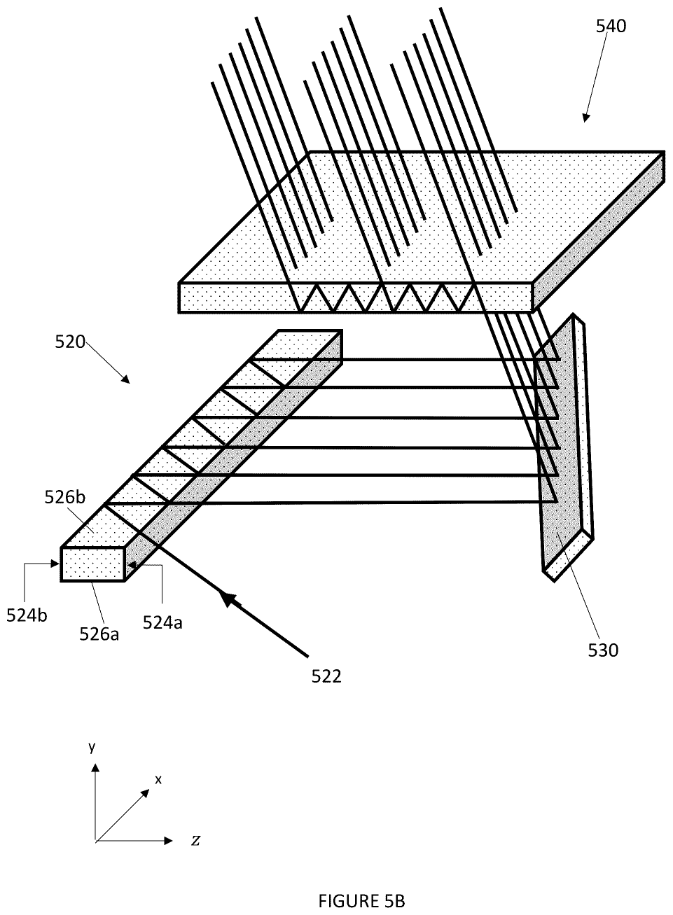

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field-including some of, preferably most of, preferably all of, the replicas of the light field that are output by the first waveguide pupil expander-from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Head-Up Display

The embodiments of the present disclosure relate to a head-up display comprising a pair of waveguides (also referred to as waveguide pupil expanders or replicators, for example the ones as described above in relation to FIGS. 5A and 5B), a coherent light source (for example, a laser) and a display device (for example, a liquid crystal on silicon spatial light modulator) arranged to display a hologram of a picture. In use, the light source of the head-up display illuminates the display device such that light is spatially modulated in accordance with the hologram displayed on the display device, thus forming a holographic wavefront. The holographic wavefront is coupled into a first waveguide where the holographic wavefront is replicated in a first direction a plurality of times (as described above) to form a one dimensional array of replicas which are then coupled into a second waveguide. The second waveguide is then arranged to waveguide the replicas of the holographic wavefront coupled in to the second waveguide from the first waveguide in a second direction (that is orthogonal to the first direction) a plurality of times (again, as described above) to form a two dimensional array of replicas. Each embodiment of the present disclosure further comprises a prismatic structure coupled to the output surface of the second waveguide, such that replicas in the two dimensional array of replicas are propagated through the prismatic structure. This prismatic structure can be any optical component with an array of prism elements through which the replicas from the second waveguide are propagated. Examples, as will be discussed in greater detail below, include turning film and glare mitigation devices. Propagation of light through such devices has its benefits and advantages, but also causes issues with regards to the image quality observed by the user of the head-up display, as will also be discussed in detail below.

It should be understand that, although a holographic head-up display is described in relation to this example, each embodiment of the present invention could in fact be used with a conventional head-up display. In such cases, the light that propagates through the waveguides may be more conventional light, modulated in accordance with an image rather than a hologram.

### Turning Film

In a first example of the present disclosure, the prismatic structure is a turning film, as shown in FIG. 7. The turning film 720 is located on an output surface 712 of the second waveguide 710. Turning film 720 consists of a layer of prism elements 720a-l that extend substantially parallel to the short edge 714 of the second waveguide 710. In this case, “substantially parallel” allows for a degree of freedom of +/−5 degrees from the “true” parallel, which will still allow the turning film 720 to perform its role within the optical system. Although the term “prism elements” is used, as discussed above, the terms “prisms”, “prismatic elements”, “prismatic structures, “elongate elements” or “elongate structures” may also be used.

This array of prism elements 720a-l is arranged to turn the replicas of the wavefront exclusively parallel to a plane of the long edge 716 of the waveguide 710. This turning effect is achieved due to the angled face of each prism element 720a-l causing different replicas to be propagated through parts of the turning film 720 with different thicknesses. As light travels slower through the material of the turning film 720 than through air, the replicas that are propagated through thinner parts of the respective prism element 720a-l arrive at the output surface (the angled faces) of the turning film 720 relatively quicker than the replicas being propagated through the thicker part of the same prism element 720a-l. As each replica is refracted through the prism element 720a-l, the cumulative effect of the differences in propagation length is a “turning” of the replicas towards the thicker end of each prism element 720a-l.

As such, the replicas of the wavefront from the first waveguide (not shown) are input to the second waveguide 710 in a direction 750 (orthogonal to the waveguide 710) and exit the turning film 720 in a direction 760 (on the plane parallel to the long edge 716 of the waveguide 710), and thus the replicas are turned by the turning film 720. The direction of propagation of the replicas is parallel to the short edge 714 of the waveguide 710, and hence the prism elements 720a-l extend in a direction substantially parallel to the propagation direction. This turning of the direction of the replicas allows for adjustment (fine-tuning) of the eye-box position.

British patent application 2401627.1, filed 7 Feb. 2024 and incorporated herein by reference, discloses further details of the functioning of such a turning film 720. The reader will understand that by “prism” it is meant any elongate structure with base faces at either end, connected by lateral faces. The base faces may be triangular (such as those of the prism elements 720a-l as shown in FIG. 7), but the skilled person would understand that they could take any shape that would allow such a turning effect to occur. Similarly, the lateral faces of the prism elements 720a-l of FIG. 7 are linear (or straight), but this need not be the case, as the elongate nature of each prism element 720a-l may be curved. As such, the shape and arrangement of the array of prism elements 720a-l shown in FIG. 7 is largely illustrative, and that aspects of said shape and arrangement may be different so long as the turning film 720 achieves the desired effect (of adjusting the direction of the replicas such that they arrive at the correct eye-box location). Other features of the array that may be different include the arrangement of each prism element 720a-l relative to one another, or that individual prism elements 720a-l may be “missing” from the array (in other words, the prism elements 720a-l may be unevenly spaced within the array).

### Glare Mitigation

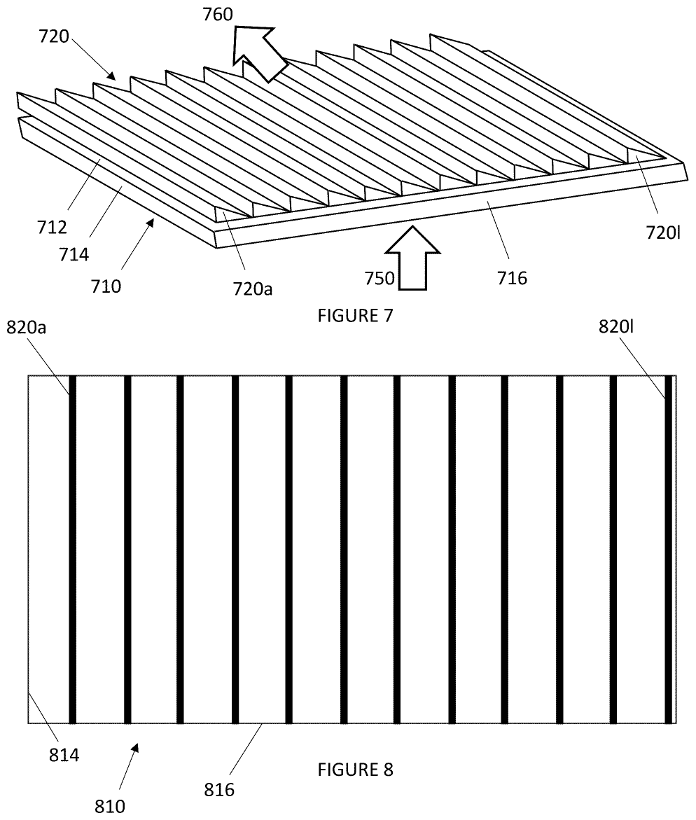

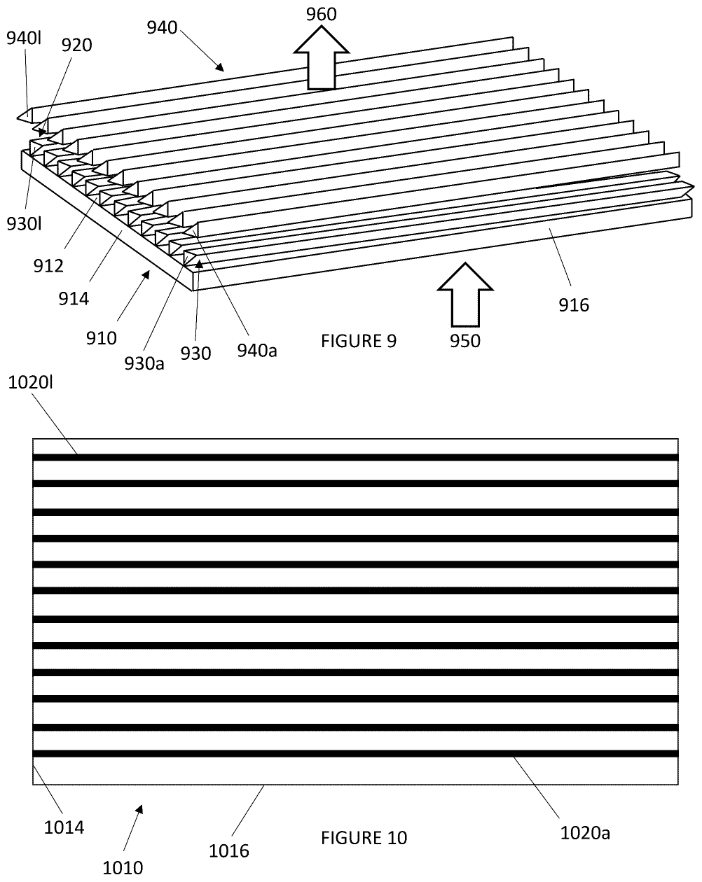

In a second example of the present disclosure, the prismatic structure is a glare mitigation device, as shown in FIG. 9. Similar to in the first example, the glare mitigation device 920 is located on an output surface 912 of the second waveguide 910. The reference numeral 910 is used in relation to FIG. 9 for consistency with the other components, however this may be the same waveguide 710 as in the first example. The glare mitigation device 920 consists of two layers 930, 940 of opposing prism elements 930a-l, 940a-l that extend substantially parallel to the long edge 916 of the second waveguide 910. As in the first example, “substantially parallel” allows for a degree of freedom of +/−5 degrees from the “true” parallel in each of the layers 930, 940 (the layers 930, 940 not necessarily being exactly parallel), which will still allow the glare mitigation device 920 to perform its role within the optical system. A first layer 930 of prism elements 930a-l is located on or next to the output surface 912 of the second guide layer 910, with the second layer 940 of prism elements 940a-l located optically downstream of the first layer 930. Although the term “prism elements” is used, as discussed above, the terms “prisms”, “prismatic elements”, “prismatic structures, “elongate elements” or “elongate structures” may also be used.

The second layer 940 mitigates or suppresses glare that would be received at the viewing window or eye-box. This is achieved by having faces of each prism element 940a-l be opaque (or nearly opaque) in order to block light that would otherwise be reflected from the output surface 912 of the waveguide 910 to the eye-box, causing glare to be visible to the user. In the absence of the reflection suppression device 920, there is a risk that ambient light incident on the waveguide 910 may be reflected and be received at the eye-box. This ambient light may then be distracting.

The first layer 930 works in cooperation with the second layer 940 to ensure that the image to be displayed is not distorted by the second layer 940. That is, if any undesired optical properties are imparted upon each replica by the prism elements 940a-l of the second layer 940, this is counteracted (or compensated for) by the corresponding prism element 930a-l of the first layer 930. This allows the replicas of the wavefront from the first waveguide (not shown), input to the second waveguide 910 in a direction 950 (orthogonal to the waveguide 910), to propagate therethrough and to exit the glare mitigation device 920 in a direction 960 (parallel to the input direction 950) with minimal distortion. The direction of propagation of the replicas is parallel to the short edge 914 of the waveguide 910, and hence the prism elements 930a-l, 940a-l extend in a direction substantially orthogonal to the propagation direction.

British patent application 2317241.4, filed 10 Nov. 2023 and incorporated herein by reference, discloses further details on the functioning of such a glare mitigation device 920. Similar to with the first example, the reader will understand that by “prism” it is meant any elongate structure with base faces at either end, connected by lateral faces. The base faces may be triangular (such as those of the prism elements 930a-l, 940a-l as shown in FIG. 9), but the skilled person would understand that they could take any shape that would allow such a glare mitigation effect to occur. Similarly, the lateral faces of the prism elements 930a-l, 940a-l of FIG. 9 are linear (or straight), but this need not be the case, as the elongate nature of each prism element 930a-l, 940a-l may be curved. As such, the shape and arrangement of the array of prism elements 930a-l, 940a-l shown in FIG. 9 is largely illustrative, and that aspects of said shape and arrangement may be different so long as the glare mitigation device 920 achieves the desired effect (of preventing or mitigating ambient light incident on the waveguide 910 being reflected to the eye-box). Other features of the array that may be different include the arrangement of each prism element 930a-l, 940a-l relative to one another, or that individual prism elements 930a-l, 940a-l may be “missing” from the array (in other words, the prism elements 930a-l, 940a-l may be unevenly spaced within the array).

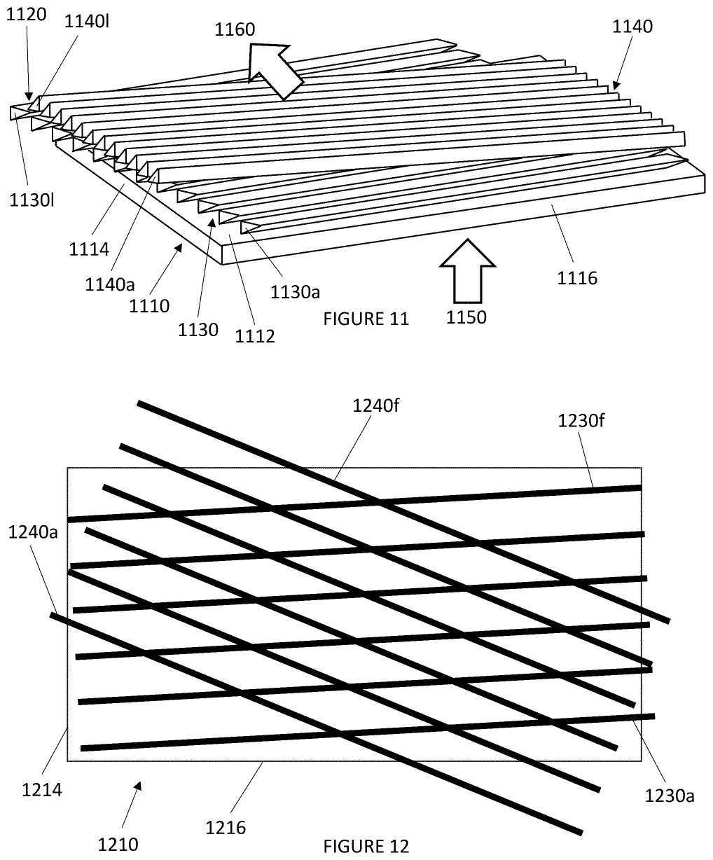

A third example of the present disclosure, similar to the second example, is shown in FIG. 11. The components are the same as in the second example, with the components assigned reference numerals 9xx in FIG. 9 being the same as the components assigned reference numerals 11xx in FIG. 11. The key difference between the second example and this third example being that the prism elements 1130a-l, 1140a-l are not substantially parallel to the long edge 1116 of the second waveguide 1110, and are instead angled with respect to said long edge 1116. The prism elements 1130a-l of the first layer 1130 extend at an angle of 25 degrees with respect to the long edge 1116 of the second waveguide 1110, whilst the prismatic elements 1140a-l of the second layer 1140 extend at an angle of 155 degrees with respect to the long edge 1116 of the second waveguide 1110. However, angles in the range of 5 to 35 degrees and 145 to 175 degrees respectively are also envisaged.

By having the prism elements 1130a-l, 1140a-l at an angle relative to one another and to the second waveguide 1110, the turning function of the turning film 720 (as described above) can be achieved whilst still providing the glare reduction of the glare mitigation device 920 (also as described above). The prism elements 1140a-l of the second layer 1140 provide a turning effect (as described above in relation to the turning film 720). This turn is normally counteracted/compensated by the first layer 1130 (as described above in relation to the second layer 940 of the glare mitigation device 920). However, by angling the first layer 1130 relative to the second layer 1140, the turning function is not counteracted/compensated on a desired plane. That is, any turning function of the second layer 1140 that is undesired is corrected by the first layer 1130, but turning function that is desired is allowed to continue. As such, the replicas of the wavefront from the first waveguide (not shown) are input to the second waveguide 1110 in a direction 1150 (orthogonal to the waveguide 1110) and exit the glare mitigation device 1120 in a direction 1160 (on the plane parallel to the long edge 1116 of the waveguide 1110), and thus the replicas are turned by the glare mitigation device 1120. In this way, the turning function of the turning film 720 (as described above) can be achieved alongside the glare mitigation function of the glare mitigation device 920 (as also described above). The direction of propagation of the replicas is parallel to the short edge 1114 of the waveguide 1110, and hence the prism elements 1130a-l, 1140a-l extend in directions neither parallel nor orthogonal to the propagation direction.

British patent application 2303536.3 (publication number GB2627988A), filed 10 Mar. 2023 and incorporated herein by reference, discloses further details on the functioning of such a glare mitigation device 1120 with an integrated turning function. Similar to with the first and second examples, the reader will understand that by “prism” it is meant any elongate structure with base faces at either end, connected by lateral faces. The base faces may be triangular (such as those of the prism elements 1130a-l, 1140a-l as shown in FIG. 11), but the skilled person would understand that they could take any shape that would allow such a turning effect to occur. Similarly, the lateral faces of the prism elements 1130a-l, 1140a-l of FIG. 11 are linear (or straight), but this need not be the case, as the elongate nature of each prism element 1130a-l, 1140a-l may be curved. As such, the shape and arrangement of the array of prism elements 1130a-l, 1140a-l shown in FIG. 11 is largely illustrative, and that aspects of said shape and arrangement may be different so long as the glare mitigation device 1120 achieves the desired effect (of preventing or mitigation ambient light incident on the waveguide 1110 being reflected to the eye-box, whilst applying a turning effect to the replicas output from the waveguide 1110). Other features of the array that may be different include the arrangement of each prism element 1130a-l, 1140a-l relative to one another, or that individual prism elements 1130a-l, 1140a-l may be “missing” from the array (in other words, the prism elements 1130a-l, 1140a-l may be unevenly spaced within the array).

### Prismatic Structure Optical Artefact Creation and Content Loss

The inventors have discovered that utilising such prismatic structures 720, 920, 1120 can sometimes cause artefacts (specifically black or dark bands) within the eye-box. Furthermore, content from the intended image can on occasion be lost due to the propagation of the replicas through these prismatic structures 720, 920, 1120, regardless of the efficiency of the propagation itself. This can cause a reduction in quality of the image viewed by the user as compared to the image intended to be displayed, with dark bands visible to the user across the image and/or parts of the image not being visible.

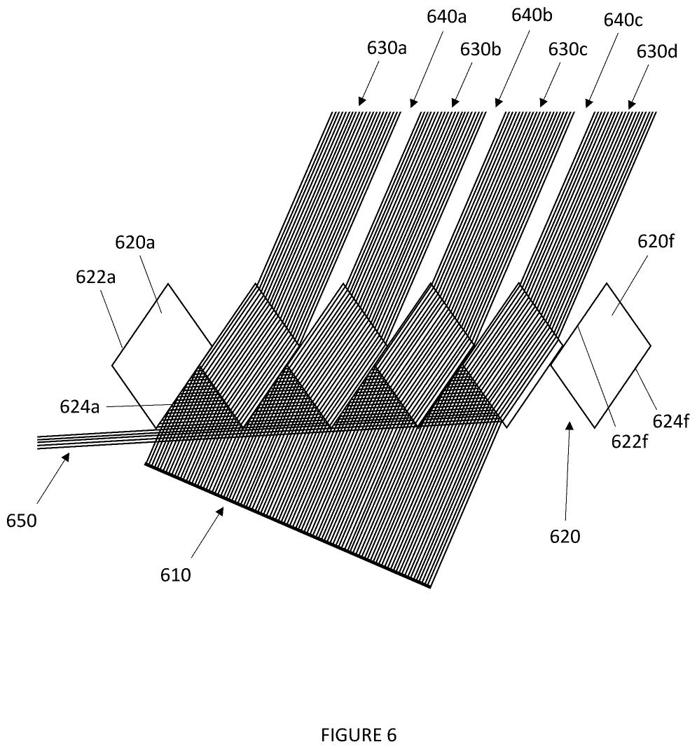

An example of why these effects occur is shown in FIG. 6, in which a wavefront 610 of light hits a prismatic structure 620, this structure 620 comprising a series of periodically repeating prism elements 620a-f. These prism elements 620a-f are shown to have a parallelogram cross-section, although as discussed above, it would become clear to the skilled person (upon reading this disclosure) that such effects would occur for any prismatic structure shape or arrangement utilised for the above functions (such as the triangular cross-sections shown in FIGS. 7, 9 and 11 or shapes involving curved edges).

As each replica of light in the wavefront 610 is refracted by the respective prism element 620a-f, the replicas travel away from a first edge 622a-f of the prism element 620a-f and towards a second edge 624a-f. The refraction of the replicas entering the prism elements 620a-f closest to the second edges 624a-f causes said replicas to be reflected back towards the first edges 622a-f. This refraction towards one side of the prism elements 620a-f causes the replicas to emerge from the prismatic structure 620 in lights bands 630a-d, interspersed with dark bands 640a-c in which no replicas are emitted. The skilled person would understand (having read this disclosure) that this effect would occur with other shapes and distributions of prism elements 620a-f.

Furthermore, some of the replicas 650 are not propagated through the prismatic structure 620, but are instead reflected and/or refracted away in a direction parallel to an axis of the array of prism elements 620a-f. The image content of this lost group of replicas 650 will therefore not reach the user, and as such this image content will be lost.

These effects may occur in the examples of FIGS. 7, 9, and 11 (as discussed above), as shown in FIGS. 8, 10 and 12 respectively. Each of FIGS. 8, 10 and 12 show an eye-box 810, 1010, 1210 of the head-up display produced by the propagation of the replicas through the prismatic structure 720, 920, 1120 of the example of the corresponding Figure (FIGS. 7, 9 and 11). Each eye-box 810, 1010, 1210 has a short side 814, 1014, 1214 and a long side 816, 1016, 1216.

The prism elements 720a-l of the first example (of FIG. 7) produce the artefact pattern shown in FIG. 8. Dark bands 820a-l are produced substantially parallel to the short edge 814 of the eye-box 810 (or at the same angle as the prism elements 720a-l of the first example, if said elements 720a-l are at an angle to the short edge 714 of the second waveguide 710, as discussed above). That is, the angle of the dark bands 820a-l relative to the short edge 814 of the eye-box 810 corresponds to the angle of the prism elements 720a-l relative to the short edge 714 of the second waveguide 710. Each dark band 820a-l corresponds to the location on the waveguide 710 where two of the prism elements 720a-l meet. These dark bands 820a-l are produced as discussed above in relation to FIG. 6, and would appear as black or dark vertical stripes through the image to the user.

The prism elements 930a-l, 940a-l of the second example (of FIG. 9) produce the artefact pattern shown in FIG. 10. Dark bands 1020a-l are produced substantially parallel to the long edge 1016 of the eye-box 1010 (or at the same angle as the prism elements 930a-l, 940a-l of the second example, if said elements 930a-l, 940a-l are at an angle to the long edge 916 of the second waveguide 910, as discussed above). That is, the angle of the dark bands 1020a-l relative to the long edge 1016 of the eye-box 1010 corresponds to the angle of the prism elements 930a-l, 940a-l relative to the long edge 916 of the second waveguide 910.

Each dark band 1020a-l corresponds to the location on the waveguide 910 where two of the prism elements 930a-l, 940a-l on either of the layers 930, 940 meet. These dark bands 1020a-l are produced as discussed above in relation to FIG. 6, and would appear as black or dark horizontal stripes through the image to the user.

Finally, the prism elements 1130a-l, 1140a-l of the third example (of FIG. 11) produce the artefact pattern shown in FIG. 12. Two sets of dark bands 1230a-f, 1240a-f are produced at angles relative to the long edge 1216 of the eye-box 1210 corresponding to the angles of the prism elements 1130a-l, 1140a-l of the two layers 1130, 1140 relative to the long edge 1116 of the second waveguide 1110.

Each dark band 1230a-f, 1240a-f corresponds to the location on the waveguide 1110 where two of the prism elements 1130a-l, 1140a-l on either of the layers 1130, 1140 meet. These dark bands 1230a-f, 1240a-f are produced as discussed above in relation to FIG. 6, and would appear as a cross-hatched pattern of black or dark angled stripes through the image to the user. Although only six of the dark bands 1230a-f, 1240a-f have been shown in FIG. 12 for each layer 1130, 1140, it would be understood that each location in which two of the prism elements 1130a-l, 1140a-l meet would produce such a band.

It would be understood by the skilled person (having read this disclosure) that the artefact patterns of FIGS. 8, 10 and 12 would change in accordance with any changes in the prism elements 720a-l, 930a-l, 940a-l, 1130a-l, 1140a-l, such as their length, distribution or shape of their extension beyond their end faces, as discussed above.

### Improved Prismatic Structures

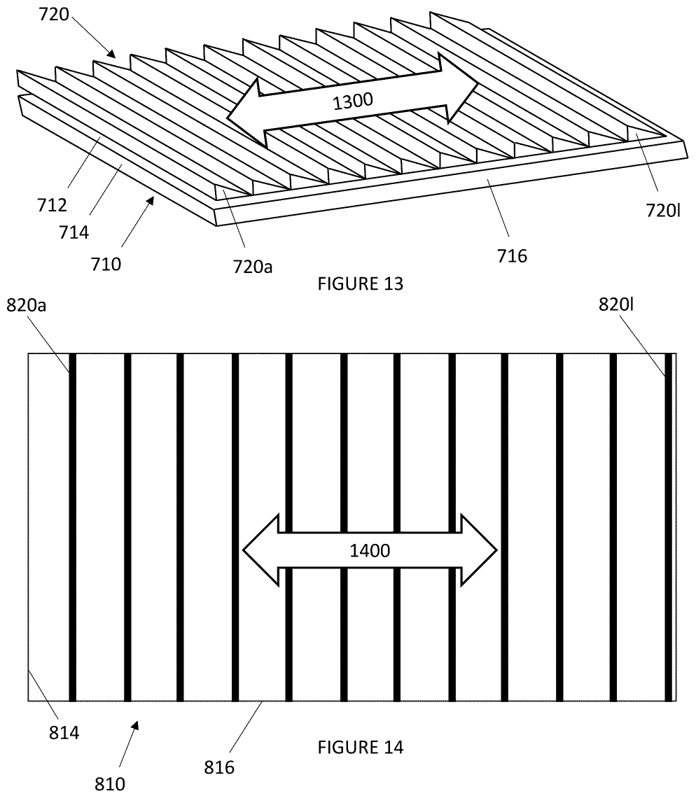

First, second and third embodiments of the disclosure are shown in FIGS. 13 and 14, 15 and 16, and 17 and 18 respectively. The same components have been labelled with the same reference numerals as described above in relation to the corresponding first, second and third examples.

The inventors have surprisingly found that driving (vibrating/oscillating) the prism elements 720a-l, 930a-l, 940a-l, 1130a-l, 1140a-l such that they have a motion with a component roughly orthogonal to the length of each prism element 720a-l, 930a-l, 940a-l, 1130a-l, 1140a-l can reduce the appearance of the dark bands 820a-l, 1020a-l, 1230a-f, 1240a-f to the user of the head-up display.

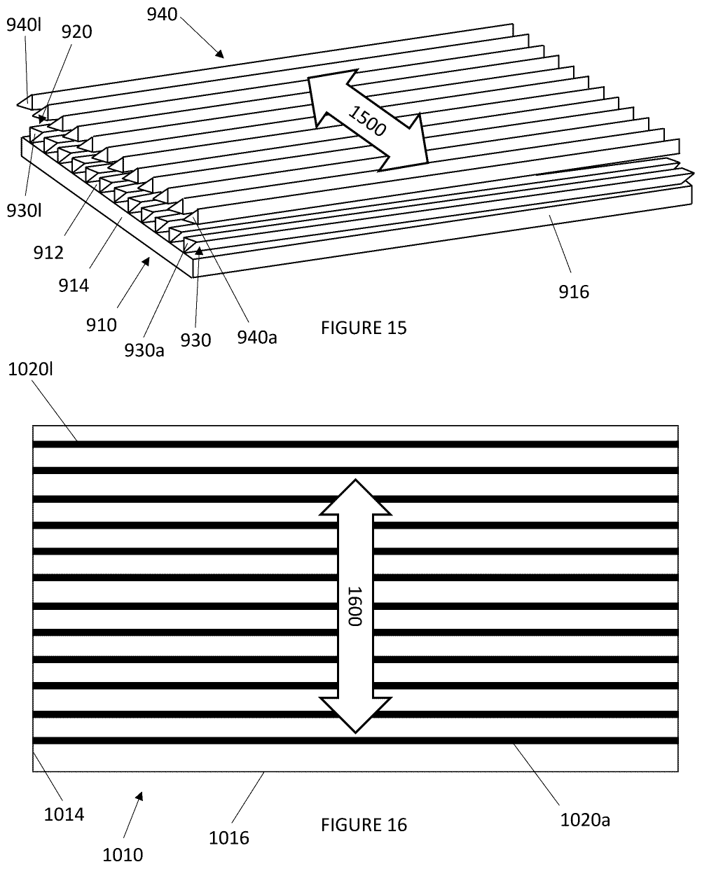

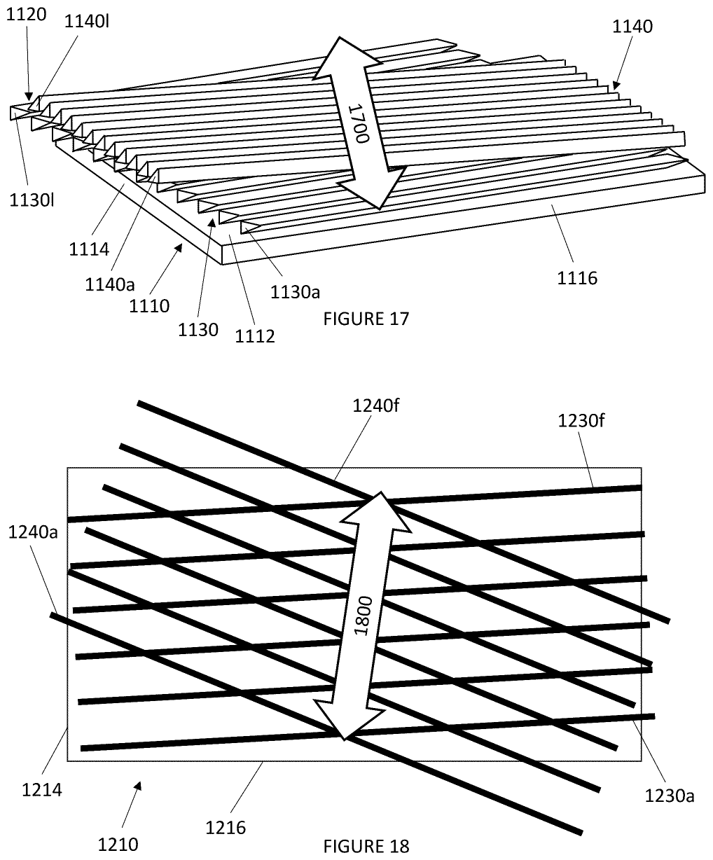

In the first embodiment, as seen in FIG. 13, the turning film 720 is moved in direction 1300, which in turn effectively moves the dark bands 820a-l in direction 1400, as seen in FIG. 14. In the second embodiment, as seen in FIG. 15, the glare mitigation device 920 is moved in direction 1500, which in turn effectively moves the dark bands 1020a-l in direction 1600, as seen in FIG. 16. In the third embodiment, as seen in FIG. 17, the glare mitigation device 1120 with the integrated turning function is moved in direction 1800, which in turn effectively moves the dark bands 1230a-f, 1240a-f in direction 1800, as seen in FIG. 18.

The motion in each embodiment reduces the appearance of the dark bands 820a-l, 1020a-l, 1230a-f, 1240a-f (produced as described above in relation to FIG. 6) and also reduces the amount of content lost from the wavefront of replicas produced by the waveguide 710, 910, 1110. Referring to FIG. 6, the motion allows each replica of the wavefront 610 to, at some point on the range of motion of the prism elements 622a-f, be properly propagated such that said replica does not form part of the lost replicas 650. As such, the content lost by the prismatic structure 620 is reduced. The motion also results in the replicas being output from the prismatic structure 620 across a range of locations, meaning the dark bands 640a-c are constantly moving. This results in the eye of the viewer struggling to perceive the dark bands 640a-c, and so the dark bands 820a-l, 1020a-l, 1230a-f, 1240a-f on the eye-box appear reduced.

The motion in each embodiment is vibration or oscillation in a plane parallel to the output surface 712, 912, 1112 of the second waveguide 710, 910, 1110. The inventors have surprisingly found that it does not require a high frequency of motion for the user to observe an improved image quality. This is unlike other parts of the optical system of the head-up display. In said other parts of the optical system, motion of optical components is required to have a high frequency in order to prevent the user from observing a lower image quality (if the frequency of the motion is lower than the frequency at which the human eye can perceive a change). However, the inventors have found that a much lower frequency can be adopted in the embodiments of the disclosure and an improved image quality will still be observed. This motion can be as low as 2 Hz (i.e. well within the range of frequencies detectable by the human eye), and anywhere in the range of 2 Hz to 60 Hz.

The motion need not be linear, it may instead by (for example) curved or elliptical in nature, so long as the primary component of the motion is in the directions 1300, 1500, 1700 described above. Indeed, the motion may be adjusted to account for the specific shape and distribution of the prism elements 720a-l, 920a-l, 1120a-l. The motion may be achieved by any suitable motor, servo, driver or other component (not shown) able to provide such a motion over a sustained period of use with minimal wear and loss of accuracy.

Additional features

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A head-up display for a vehicle, wherein the head-up display comprises:
an optical component arranged to emit light from a first surface thereof;
a light control layer having a plurality of elongate structures and being arranged in cooperation with the optical component on an optical path between the first surface and an eye-box of the head-up display; and
a driver arranged to move the light control layer between a first position and a second position, wherein the motion is on a plane parallel to a plane of the first surface.

2. The head-up display of claim 1, wherein the motion is linear.

3. The head-up display of claim 1, wherein the light control layer is arranged to change an angle of light propagating therethrough.

4. The head-up display of claim 3, wherein the first surface has a first dimension and a second dimension, the first dimension being larger than the second dimension, the motion being substantially parallel to the first dimension.

5. The head-up display of claim 4, wherein the plurality of elongate structures is arranged such that each elongate structure extends in a direction substantially parallel to the second dimension.

6. The head-up display of claim 1, wherein the first surface is at least partially reflective and the light control layer is arranged to suppress reflections of sunlight received on an optical path to the eye-box.

7. The head-up display of claim 6, wherein the first surface has a first dimension and a second dimension, the first dimension being larger than the second dimension, the motion being substantially parallel to the second dimension.

8. The head-up display of claim 7, wherein the plurality of elongate structures is arranged such that each elongate structure extends in a direction substantially parallel to the first dimension.

9. The head-up display of claim 7 further comprising a compensation layer located on an optical path between the first surface and the light control layer, the compensation layer having a plurality of elongate structures arranged such that each elongate structure extends in a direction substantially parallel to the first dimension.

10. The head-up display of claim 9, wherein the elongate structures of the compensation layer are shaped to compensate for a distortion to the light caused by a corresponding one of the elongate structures of the light control layer.

11. The head-up display of claim 6, wherein the first surface has a first dimension and a second dimension, the first dimension being larger than the second dimension, the motion being at an angle of 5 to 35 degrees relative to the second dimension.

12. The head-up display of claim 11, wherein the plurality of elongate structures is arranged such that each elongate structure extends in a direction at an angle of 5 to 35 degrees relative to the first dimension.

13. The head-up display of claim 11 further comprising a compensation layer located on an optical path between the first surface and the light control layer, the compensation layer having a plurality of elongate structures arranged such that each elongate structure extends in a direction at an angle of 145 to 175 degrees relative to the first dimension.

14. The head-up display of claim 13, wherein the elongate structures of the compensation layer are shaped to compensate for a distortion to the light caused by a corresponding one of the elongate structures of the light control layer.

15. The head-up display of claim 1, wherein the optical component comprises a replicator arranged to receive light and replicate the light to form a plurality of replicas of the light by waveguiding between a reflective surfaces and a transmissive-reflective surface, and wherein the transmissive-reflective surface forms an output surface for the plurality of replicas of the light.

16. The head-up display of claim 1, wherein the motion has at least one of (i) a frequency of at least 2 hertz or (ii) a frequency within a range of 2 to 60 hertz.

17. The head-up display of claim 1, wherein the motion has at least one of (i) a magnitude of at least 0.3 millimeters, or (ii) a magnitude within a range of 0.3 to 3 millimeters.

18. The head-up display of claim 1, further comprising an optical combiner, wherein at least one of (i) the optical combiner is located on an optical path between the optical component and a user or (ii) the optical combiner is a windscreen of a vehicle.

19. The head-up display of claim 1, wherein the elongate structures are prismatic structures.

20. A method of operating a head-up display for a vehicle, wherein the method comprises:
emitting light from a first surface of an optical component of the head-up display; and
moving a light control layer, using a driver, between a first position and a second position;
wherein the light control layer has a plurality of elongate structures and is arranged in cooperation with the optical component on an optical path between the first surface and an eye-box of the head-up display; and
wherein the motion is on a plane parallel to a plane of the first surface.
